(19) United States
(12) Patent Application Publication
(10) Pub. No.: US 2009/0251848 A1
(43) Pub. Date: Oct. 8, 2009

(54) DESIGN STRUCTURE FOR METAL-INSULATOR-METAL CAPACITOR USING VIA AS TOP PLATE AND METHOD FOR FORMING

(75) Inventors: Frederick G. Anderson, South Burlington, VT (US); Zhong-Xiang He, Essex Junction, VT (US)

Correspondence Address: HOFFMAN WARNICK LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 12/062,606

(22) Filed: Apr. 4, 2008

(51) Int. Cl. H01G 4/06; G06F 9/455; H01G 9/00

(52) U.S. Cl. 361/311; 716/11; 29/25.03

(57) ABSTRACT

A design structure for a metal-insulator-metal (MIM) capacitor using a via as a top plate and method for forming is described. In one embodiment, the MIM capacitor structure comprises a bottom plate and a capacitor dielectric layer formed on the bottom plate and at least one via formed on the capacitor dielectric layer. The at least one via provides a top plate of the MIM capacitor.

### BACKGROUND

This invention relates generally to integrated circuit design, and more specifically to a design structure for a metal-insulator-metal (MIM) capacitor that uses a via as a top plate.

A typical MIM capacitor is made from two sets of metal levels with at least one metal level being connected to standard wiring metals through at least one via. One of the metal levels forms a top plate and the other metal level forms a bottom plate, and the two levels are separated by a dielectric layer. Generally, the bottom plate is larger than the top plate. In order to meet increasing demand for MIM capacitors of smaller capacitance, semiconductor manufacturers typically try to tighten up the ground rules for designing the capacitors and minimize the size of the top plate, which determines the capacitance value of the MIM capacitor. Minimizing the size of the top plate is limited by the need to have the top plate large enough to ensure that the via connecting the top plate to standard metal lines is indeed contacted to the top plate and not hanging over the edge. In particular, if the top plate is too small, then the via that attaches to the top of it has trouble actually landing on the plate and will typically fall off to the side. This puts a severe limit on just how small the dimensions of the top plate can be. A limit on how small the size of the top plate can be restricted results in a limit in how much capacitance values can be reduced.

### SUMMARY

In one embodiment, there is a metal-insulator-metal (MIM) capacitor structure that comprises a bottom plate; a capacitor dielectric layer formed on the bottom plate; and at least one via formed on the capacitor dielectric layer, wherein the at least one via provides a top plate of the MIM capacitor.

In a second embodiment, there is a design structure of a metal-insulator-metal (MIM) capacitor embodied in a machine readable medium. In this embodiment, the design structure of the metal-insulator-metal (MIM) capacitor comprises a bottom plate; a capacitor dielectric layer formed on the bottom plate; and at least one via formed on the capacitor dielectric layer, wherein the at least one via provides a top plate of the MIM capacitor.

In a third embodiment, there is a method for forming a metal-insulator-metal (MIM) capacitor structure. The method comprises: providing a bottom plate; depositing a capacitor dielectric layer on the bottom plate; and forming at least one via on the capacitor dielectric layer, wherein the at least one via provides a top plate of the MIM capacitor.

### BRIEF DESCRIPTION OF THE DRAWINGS

FIG. 1 shows a cross-sectional view of a MIM capacitor structure according to one embodiment of the invention;

FIGS. 2A-2F show the method for forming the MIM capacitor structure depicted in FIG. 1; and

FIG. 3 shows a schematic cross-sectional view of a MIM capacitor structure according to another embodiment of the invention.

FIG. 4 shows a flow diagram describing a design process that can be used in the semiconductor design, manufacturing and/or test of the structures embodied in this invention.

### DETAILED DESCRIPTION

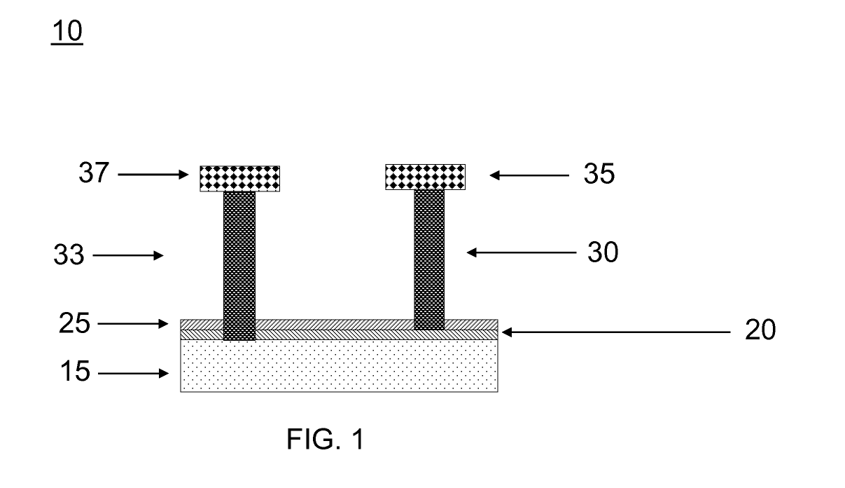

FIG. 1 shows a cross-sectional view of a MIM capacitor structure 10 according to one embodiment of the invention. Although not shown, the MIM capacitor structure 10 is formed on a substrate which may comprise a semiconductor material such as silicon, germanium, silicon germanium, gallium arsenide, silicon carbide, aluminum oxide, etc. An interconnection wiring level 15, which is the bottom plate of the MIM capacitor structure 10, is formed on the substrate. In one embodiment, the bottom plate formed by the interconnection wiring level 15 (hereinafter “the bottom plate”) comprises a wiring metal structure fabricated in complementary metal-oxide-semiconductor (CMOS), p-channel metal-oxide-semiconductor (PMOS) or n-channel metal-oxide-semiconductor (NMOS) back-end-of-line technologies. Although not shown in FIG. 1, those skilled in the art will recognize that the MIM capacitor structure 10 can have additional metal levels with dielectric layers placed between the substrate and the bottom plate 15.

Referring back to FIG. 1, a capacitor dielectric layer 20 is formed on the bottom plate 15. In one embodiment, the capacitor dielectric layer 20 is deposited on the bottom plate 15 by a deposition technique such as chemical vapor deposition (CVD), molecular CVD or atomic layer deposition. The capacitor dielectric layer 20 may comprise any suitable capacitor dielectric material such as an oxide, silicon dioxide, a nitride, a low K dielectric, a high dielectric constant material (e.g., tantalum pentoxide), etc. The capacitor dielectric layer 20 generally has a thickness of a few hundred Angstroms depending on the specific application of the MIM capacitor structure 10, its expected operating voltage and the deposition capabilities for the fabrication line to manufacture it. Furthermore, the capacitor dielectric layer 20 may be composed of a single or a plurality of layers. The composition and thickness of the single or multiple layers will effect the capacitance value of the MIM capacitor structure 10.

As shown in FIG. 1, an etch stop layer 25 is formed on the capacitor dielectric layer 20. In one embodiment, the etch stop layer 25 is deposited on the capacitor dielectric layer 20 by a deposition technique such as plasma enhanced chemical vapor deposition (PECVD). The etch stop layer 25 may comprise any suitable etch stop material such as Si₃N₄ and SiCN. The etch stop layer 25 generally has a thickness in the range from about 100 to about 1000 Angstroms.

One function of the etch stop layer 25 is to control the depth of a via 30 formed on the capacitor dielectric layer 20. In one embodiment, the via 30 is formed by using a photolithography mask and reactive plasma dry etching. In fact, an additional photolithographic mask may be employed in order to ensure that the via 30 landing over the MIM capacitor does not etch through dielectric layer 20. The via 30 may be filled with a material such as aluminum (Al), copper (Cu), tungsten (W), AlCu, Al₂Cu, etc. The via 30 generally has a thickness that ranges from about 4000 to about 40000 Angstroms.

Another interconnection wiring level 35 is formed on the via 30. In one embodiment, the interconnection wiring level 35 comprises a wiring metal structure fabricated in CMOS, PMOS or NMOS back-end-of-line technologies. In this embodiment, the interconnection wiring level 35 is smaller in length than the bottom plate 15.

In this configuration, the via 30 forms the top plate of a MIM capacitor which also comprises the bottom plate 15 and the capacitor dielectric layer 20. Because the via 30 is used as the top plate of the MIM capacitor on the structure on the right-hand side of FIG. 1, this MIM capacitor is able to attain a relatively small capacitance. As used herein, a relatively small capacitance is a capacitance that is less than about 5 femtofarad (fF). Since the via 30 has dimensions that range from 1000 to 15000 Angstroms, the MIM capacitor structure 10 is able to attain capacitance values that are less than about 5 fF, with a preferred range being from about 0.1 fF to about 4 fF. Those skilled in the art will recognize that these capacitance values will depend on the technology node (e.g., 0.18 μm, 0.25 μm) and the dimensions of the via itself.

Although the MIM capacitor structure 10 in FIG. 1 is shown having an etch stop layer 25, those skilled in the art will recognize that the MIM capacitor can forego the use of the etch stop layer. Generally, the etch stop layer 25 is used to ensure that the via 30 sits on the capacitor dielectric layer 20 and does not bore through the capacitor dielectric layer 20. Because certain capacitor dielectric materials have properties that are equivalent to the etch stop layer 25, the capacitor dielectric layer 20 can be used to ensure that the via 30 sits on the capacitor dielectric layer 20 and does not bore through.

The MIM capacitor structure 10 shown in FIG. 1 further includes another structure on the left-hand side in addition to the MIM capacitor. In this configuration, a via 33 extends through the etch stop layer 25 and the capacitor dielectric layer 20, making a connection between a wiring level 37 and the bottom plate 15.

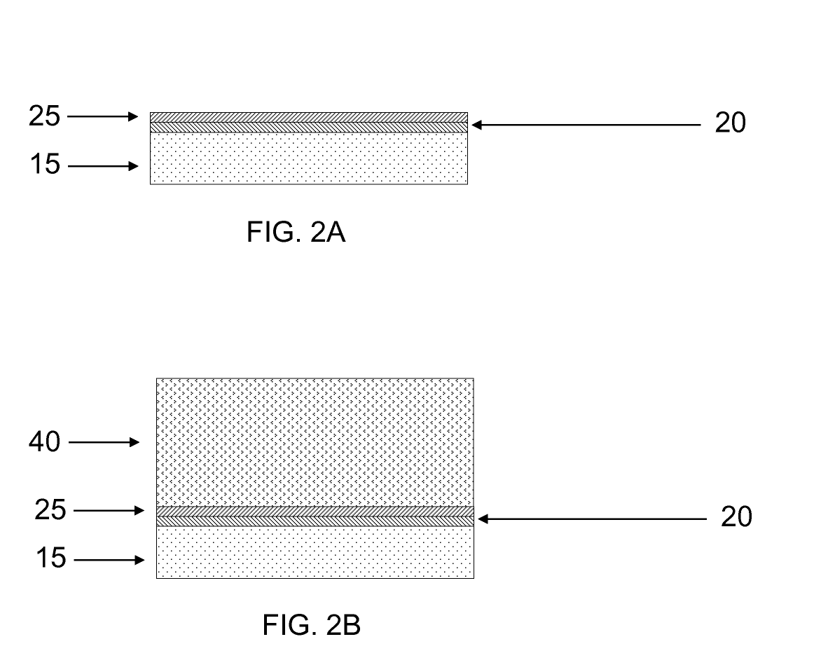

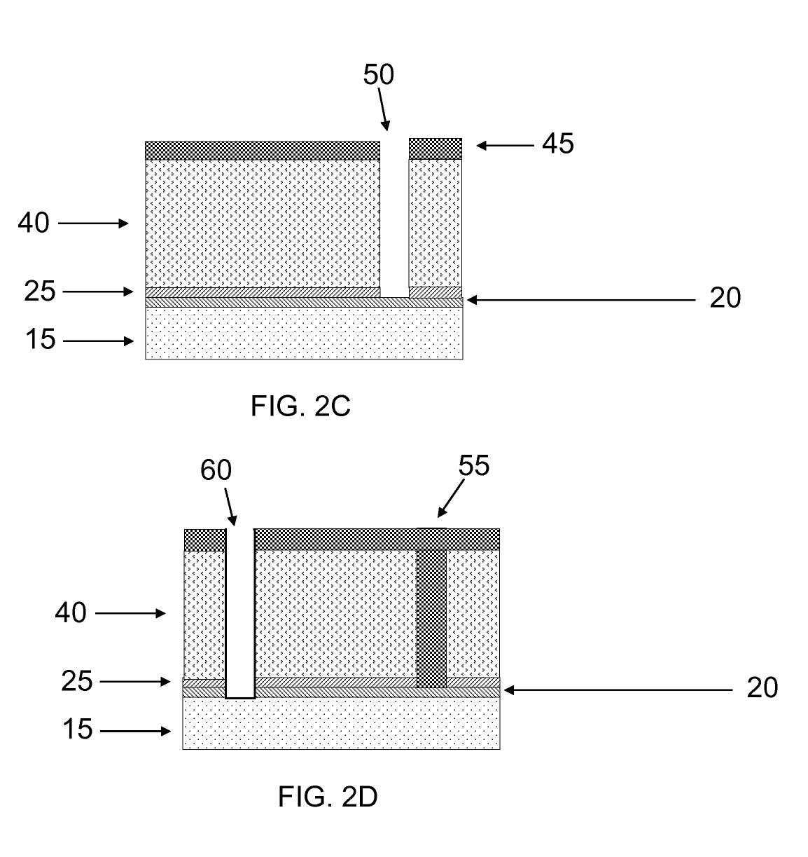

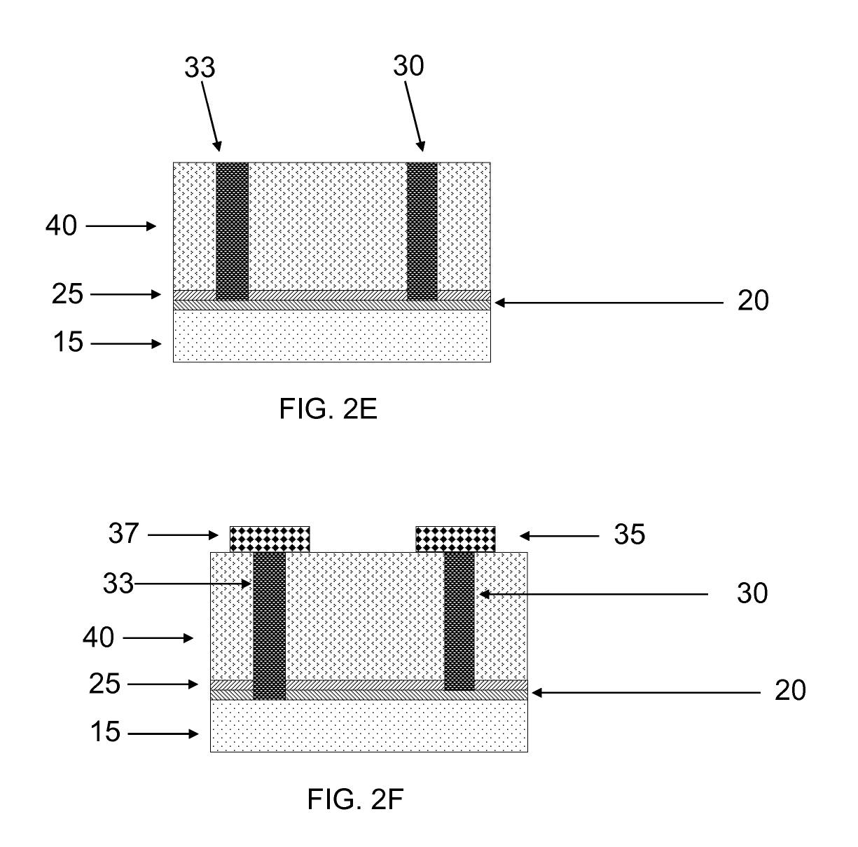

FIGS. 2A-2F show the method for forming the MIM capacitor structure 10 depicted in FIG. 1. As shown in FIG. 2A, the initial structure for forming the MIM capacitor structure 10 comprises the bottom plate 15 with the capacitor dielectric layer 20 deposited on the bottom plate 15 and the etch stop layer 25 deposited on the capacitor dielectric layer 20. This initial structure can be formed using well-known deposition techniques as well as lithography processing and reactive ion etching (RIE) to form the structure.

FIG. 2B shows an interlevel dielectric layer 40 deposited on the etch stop layer 25. In one embodiment, the interlevel dielectric layer 40 is deposited on the etch stop layer 25 by a technique such as chemical vapor deposition (CVD), spin-on glass. The interlevel dielectric layer 40 may comprise any suitable dielectric material such as silicon dioxide glass, fluorinate silicate glass, spin-on glass. The interlevel dielectric layer 40 generally has a thickness that ranges from about 5000 to about 40000 Angstroms. In addition to depositing the interlevel dielectric layer 40, a well-known planarization technique such as chemical-mechanical polishing (CMP) is used to planarize the top of the initial structure.

FIG. 2C shows the formation of the via 30 utilizing conventional processes well known to those skilled in the art. For example, conventional lithography and dry etching such as RIE, ion beam etching, plasma-etching or laser ablation can be used for forming the via 30 in the interlevel dielectric layer 40. In one embodiment, a mask 45 is deposited over the interlevel dielectric layer 40 and an opening 50 is formed in the interlevel dielectric by using RIE. The opening 50 extends down to stop on the top of the capacitor dielectric layer 20. A strip resist process is then used to remove the mask 45.

FIG. 2D shows the formation of via 33 utilizing conventional processes well known to those skilled in the art. In one embodiment, another mask 55 is deposited over the interlevel dielectric layer 40 and another opening 60 is formed in the interlevel dielectric by using RIE. The opening 60 extends down to stop on the top of the bottom plate 15. A strip resist process is then used to remove the mask 55.

FIG. 2E shows vias 30 and 33 filled with a material such as aluminum (Al), copper (Cu), tungsten (W), AlCu, Al₂Cu, etc. In one embodiment, the vias are filled by a deposition technique such as chemical vapor deposition, physical vapor deposition, or atomic layer deposition. After filling the vias, other operations can be performed that include a planarization step such as CMP.

FIG. 2F shows the final formation of the MIM capacitor structure 10 shown in FIG. 1. In this part of the formation, interconnection wiring levels 35 and 37 are formed on the vias 30 and 33, respectively, by a deposition technique such as physical vapor deposition. In this embodiment, the interconnection wiring levels 35 and 37 are smaller in length than the bottom plate 15.

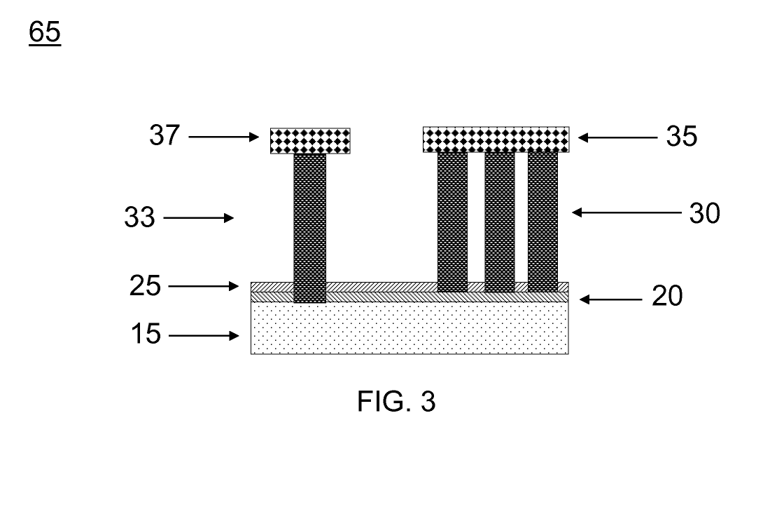

FIG. 3 shows a schematic cross-sectional view of a MIM capacitor structure 65 according to another embodiment of the invention. The MIM capacitor structure 65 includes an array of vias that form a single electrically continuous top plate of the capacitor. The array of vias (shown in FIG. 3 as the group on the right-hand side of the structure) is formed generally in the same manner described above for FIGS. 2A-2F but this embodiment includes multiple vias. Those skilled in the art will recognize that the array can include much more vias and that the amount shown in FIG. 1 is solely for illustration purposes and is not limiting. In this embodiment, each via in the array forms the top plate and connects to the capacitor dielectric layer 20 which is connected to the bottom plate 15.

As a result, the MIM capacitor structure 65 of FIG. 3 can be used to attain a capacitor that has a relatively high capacitance. As used herein, a relatively high capacitance is a capacitance that is greater than 5 fF. Since the array of vias 30 has dimensions that range from 1000 to 15000 Angstroms, the MIM capacitor structure 65 is able to attain capacitance values that are greater than 5 fF, with a preferred range being from about 10 fF to about 100 fF. In another embodiment, the preferred range may extend from about 10 fF into the picofarad (pF) range.

Like FIG. 1, The MIM capacitor structure 65 shown in FIG. 3 further includes another structure on the left-hand side in addition to the MIM capacitor. In this configuration, the via 33 extends through the etch stop layer 25 and the capacitor dielectric layer 20, making a connection between the wiring level 37 and the bottom plate 15.

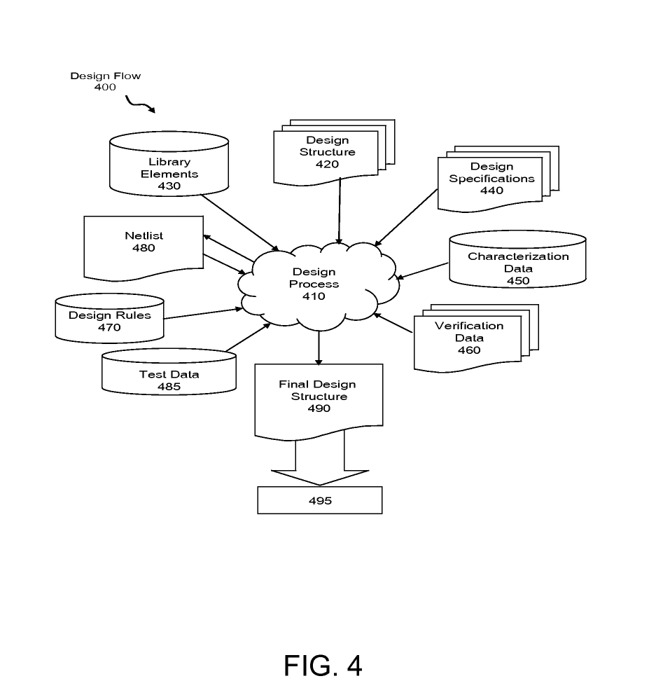

FIG. 4 shows a block diagram of an exemplary design flow 400 used for example, in semiconductor design, manufacturing, and/or test. Design flow 400 may vary depending on the type of IC being designed. For example, a design flow 400 for building an application specific IC (ASIC) may differ from a design flow 400 for designing a standard component. Design structure 420 is preferably an input to a design process 410 and may come from an IP provider, a core developer, or other design company or may be generated by the operator of the design flow, or from other sources. Design structure 420 comprises an embodiment of the aspects shown in FIGS. 1 and 3 in the form of schematics or HDL, a hardware-description language (e.g., Verilog, VHDL, C, etc.). Design structure 420 may be contained on one or more machine readable medium. For example, design structure 420 may be a text file or a graphical representation of an embodiment of the aspects shown in FIGS. 1 and 3. Design process 410 preferably synthesizes (or translates) an embodiment of the aspects shown in FIGS. 1 and 3 into a netlist 480, where netlist 480 is, for example, a list of wires, transistors, logic gates, control circuits, I/O, models, etc. that describes the connections to other elements and circuits in an integrated circuit design and recorded on at least one of machine readable medium. For example, the medium may be a CD, a compact flash, other flash memory, a packet of data to be sent via the Internet, or other networking suitable means. The synthesis may be an iterative process in which netlist 480 is resynthesized one or more times depending on design specifications and parameters for the circuit.

Design process 410 may include using a variety of inputs; for example, inputs from library elements 430 which may house a set of commonly used elements, circuits, and devices, including models, layouts, and symbolic representations, for a given manufacturing technology (e.g., different technology nodes, 32 nm, 45 nm, 90 nm, etc.), design specifications 440, characterization data 450, verification data 460, design rules 470, and test data files 485 (which may include test patterns and other testing information). Design process 410 may further include, for example, standard circuit design processes such as timing analysis, verification, design rule checking, place and route operations, etc. One of ordinary skill in the art of integrated circuit design can appreciate the extent of possible electronic design automation tools and applications used in design process 410 without deviating from the scope and spirit of the disclosure. The design structure of the disclosure is not limited to any specific design flow.

Design process 410 preferably translates aspects shown in FIGS. 1 and 3, along with any additional integrated circuit design or data (if applicable), into a second design structure 490. Design structure 490 resides on a storage medium in a data format used for the exchange of layout data of integrated circuits and/or symbolic data format (e.g. information stored in a GDSII (GDS2), GL1, OASIS, map files, or any other suitable format for storing such design structures). Design structure 490 may comprise information such as, for example, symbolic data, map files, test data files, design content files, manufacturing data, layout parameters, wires, levels of metal, vias, shapes, data for routing through the manufacturing line, and any other data required by a semiconductor manufacturer to produce aspects shown in FIGS. 1 and 3. Design structure 490 may then proceed to a stage 495 where, for example, design structure 490: proceeds to tape-out, is released to manufacturing, is released to a mask house, is sent to another design house, is sent back to the customer, etc.

It is apparent that there has been provided by this invention a design structure for a metal-insulator-metal (MIM) capacitor using a via as a top plate and method for forming is described. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A metal-insulator-metal (MIM) capacitor structure, comprising:
a bottom plate;
a capacitor dielectric layer formed on the bottom plate; and
at least one via formed on the capacitor dielectric layer, wherein the at least one via provides a top plate of the MIM capacitor.

2. The structure according to claim 1, further comprising an etch stop layer formed on the capacitor dielectric layer to control depth of the at least one via.

3. The structure according to claim 1, wherein the MIM capacitor has a relatively small capacitance.

4. The structure according to claim 3, wherein the relatively small capacitance is less than about 5 fF.

5. The structure according to claim 4, wherein the relatively small capacitance ranges from about 0.1 fF to about 4 fF.

6. The structure according to claim 1, wherein the at least one via comprises an array of vias formed on the capacitor dielectric layer, wherein the array of vias form a single electrically continuous top plate.

7. The structure according to claim 6, wherein the MIM capacitor has a relatively high capacitance.

8. The structure according to claim 7, wherein the relatively high capacitance is greater than 5 fF.

9. The structure according to claim 8, wherein the relatively high capacitance ranges from about 10 fF to about 100 fF.

10. A design structure of a metal-insulator-metal (MIM) capacitor embodied in a machine readable medium, the design structure of the metal-insulator-metal (MIM) capacitor, comprising:
a bottom plate;
a capacitor dielectric layer formed on the bottom plate; and
at least one via formed on the capacitor dielectric layer, wherein the at least one via provides a top plate of the MIM capacitor.

11. The design structure of claim 10, wherein the design structure comprises a netlist.

12. The design structure of claim 10, wherein the design structure resides on storage medium as a data format used for the exchange of layout data of integrated circuits.

13. The design structure of claim 10, wherein the design structure comprises a text file or a graphical representation.

14. A method of forming a metal-insulator-metal (MIM) capacitor structure, comprising:
providing a bottom plate;
depositing a capacitor dielectric layer on the bottom plate; and
forming at least one via on the capacitor dielectric layer, wherein the at least one via provides a top plate of the MIM capacitor.

15. The method according to claim 14, further comprising depositing an etch stop layer on the capacitor dielectric layer to control depth of the at least one via.

16. The method according to claim 14, wherein the MIM capacitor has a relatively small capacitance, wherein the relatively small capacitance is less than about 5 fF.

17. The method according to claim 14, wherein the forming of the at least one via comprises forming an array of vias on the capacitor dielectric layer, wherein the array of vias form a single electrically continuous top plate.

18. The method according to claim 17, wherein the MIM capacitor has a relatively high capacitance, wherein the relatively high capacitance is greater than 5 fF.

19. The method according to claim 14, wherein the forming of the at least one via comprises, depositing an interlayer dielectric layer over the capacitor dielectric layer, forming an opening in the interlayer dielectric layer by performing an etch operation that stops on top of the capacitor dielectric layer.

20. The method according to claim 19, further comprising filling the at least one via with a metal.
